(19) United States
(12) Patent Application Publication
(10) Pub. No.: US 2017/0151510 A1
(43) Pub. Date: Jun. 1, 2017

(54) DOWNHOLE LIQUID / GAS SEPARATOR

(71) Applicant: Delwin E. Cobb, Houston, TX (US)

(72) Inventor: Delwin E. Cobb, Houston, TX (US)

(21) Appl. No.: 14/955,759

(22) Filed: Dec. 1, 2015

(51) Int. Cl. B01D 19/00; E21B 43/38; E21B 43/12

(52) U.S. Cl. CPC B01D 19/0036; B01D 19/0042; E21B 43/128; E21B 43/127; E21B 43/38

(57) ABSTRACT

An apparatus for separating gas bubbles from a liquid stream, which may be a liquid hydrocarbon, includes a suction pipe on which a plurality of separator modules are supported. Each separator module includes an upwardly disposed annular opening that surrounds a portion of the suction pipe. The apparatus is disposed vertically within a well. Gas bubbles introduced into the well below the apparatus flow upwardly around the curved exterior of the module as a liquid phase is drawn radially inwardly and then downwardly into the annular opening of each module to a plurality of radially extending flow barriers within the module. The radially extending flow barriers define a plurality of flow control pathways that terminate at an aperture in the wall of the suction pipe so that a substantially gas-free liquid phase may be drawn into the suction pipe and delivered through the suction pipe to an artificial lift pump.

### BACKGROUND

Field of the Invention

The present invention relates to the downhole separation of liquid from gas in a well drilled to recover liquids, such as hydrocarbons or water, from geologic formations in the earth's crust. The present invention relates to the removal of gas bubbles from liquids in the well for more efficient production of the liquids to the surface.

Background of the Related Art

Hydrocarbons may reside in geologic formations in the earth's crust in the form of a volatile liquid hydrocarbon that remains in a liquid phase until a change in state that promotes boiling of at least some components. Lowered pressure is usually the change in state that results in the formation of bubbles. For example, a pressure change may result from production from a geologic formation having little or no pressure maintenance. Liberated gas bubbles will generally tend to rise in a column of the liquid due to the buoyancy of the gas bubbles relative to the remaining liquid phase.

The liberation of gas bubbles in the well can be problematic for wells that are artificially produced; that is, wells in which pumps are provided to boost the pressure of the liquid phase and to deliver a stream of liquid to the surface. For example, oil may liberate one or more components as a gas in response to a decrease in pressure, and the remaining liquid phase can be pumped from the well. The presence of gas bubbles liberated from the liquid phase may interfere with the operation of artificial lift pumps by displacing liquid oil from the pump and by collapsing upon activation of the pump, a problem referred to in the field as pump lock. This problem is known in the artificial lift industry as gas locking.

A liquid/gas separator is a device that separates liberated gas bubbles from a volatile liquid to thereby limit pump efficiency caused by the presence of gas bubbles in the working cylinder of the pump. A liquid/gas separator can substantially increase the efficiency of the pump, thereby preventing pump damage and saving energy that is consumed in pumping operations.

BRIEF SUMMARY

One embodiment of the apparatus of the present invention comprises a suction pipe onto which a plurality of liquid/gas separator modules are supported. The plurality of liquid/gas separator modules are arranged on the suction pipe in a vertical stack, one spaced from the others, along the exterior wall of a suction pipe. Each of the liquid/gas separation modules includes an upwardly disposed annular opening surrounding the exterior wall of the suction pipe. Produced fluids enter the well from a geologic formation below the apparatus and are drawn upwardly, around the exterior wall of the liquid/gas separation modules of the apparatus. The gas phase, or gas bubbles, within the produced fluid stream tend to continue to move upwardly after flowing upwardly and around the exterior wall of the liquid/gas separation modules due to buoyancy, while the liquid phase of the produced fluids is drawn radially inwardly towards the exterior wall of the suction pipe and then downwardly into the upwardly disposed annular opening of each of the modules to a plurality of radially extending flow barriers recessed within the interior of each module. It will be understood that the liquid phase flow entering each module through the upwardly disposed opening is circumferentially distributed about the suction pipe to provide a uniform rate of entry about the circumference of the opening.

Radially-extending flow barriers disposed within each of the liquid/gas separation modules together define a plurality of flow control pathways originating near the opening of the module and terminating at an aperture or at a set of apertures, wherein a set may consist of two or more angularly spaced apertures in the exterior wall of the suction pipe. Flow dividers within each module direct the liquid phase flow entering the opening of the module to one or more inlets to the flow control pathways defined by the radially-extending flow barriers of the module. It will be understood that, for a given rate of well production, the flow rate of the separated liquid phase of the produced fluids into each module will be a function of the number of modules on the suction pipe of the apparatus, and the flow rate into the opening of each module will decrease as the number of modules increases. The number of modules included in an embodiment of the apparatus can be, therefore, selected to limit the rate at which the liquid phase of the produced fluids enter the upwardly disposed annular opening of each module so that the downward flow velocity of the liquid phase of the produced fluid entering the upwardly disposed annular opening of each module is sufficiently low to prevent the unwanted entrainment of gas bubbles, which are preferably liberated to flow upwardly in the wellbore away from the apparatus.

In some embodiments, the exterior profile of each liquid/gas separation module may be shaped to promote the separation of a gaseous phase, i.e. upwardly migrating gas bubbles, from a liquid phase that flows radially inwardly towards the suction pipe and then downwardly to enter the annular opening of a module. By placing the apparatus above the well perforations through which produced fluids enter the well, the produced fluids approach the upwardly disposed annular opening of each module from below. The buoyancy of the gas bubbles causes the gas bubbles to continue to move in an upward direction as the liquid phase of the produced fluids are drawn radially inwardly towards the suction pipe and then downwardly and into the upwardly disposed annular opening of the module. The flow control pathways disposed within each module of the apparatus of the present invention deliver a substantially gas-free liquid phase stream to the aperture in the suction pipe that is aligned with the terminus of the flow control pathways in the module. Ideally, a substantially gas-free liquid stream leaves the module and enters the bore of the suction pipe. An artificial lift pump, such as a sucker rod pump or a submersible electric motor-driven pump, can be used to intermittently or continuously draw produced fluids into the apparatus. It will be understood that since the modules of the apparatus can be adapted for a specific flow velocity of the entering liquid phase of the produced fluid, an embodiment of the apparatus of the present invention adapted for use in connection with a sucker rod pump should be designed and sized to accommodate the peak flow velocity produced during an upstroke of the sucker rod pump, meaning that it may require more liquid/gas separation modules or axially longer liquid/gas separation modules on the apparatus to compensate for the increased peak flow velocity associated with the cyclic operation of sucker rod pumps, whereas an embodiment of the apparatus of the present invention adapted for use in connection with a continuously operating submersible electric motor-driven pump can be designed and sized for a generally lower, continuous flow velocity, meaning fewer modules for the same daily production rate.

In some embodiments of the apparatus of the present invention, a downward flow velocity of about 0.5 feet per second for the liquid phase of the produced fluid entering the openings of the modules of the apparatus provides for optimal separation of the gas phase (bubbles) from the liquid phase at the module opening. Increased flow velocities risk entraining gas bubbles into the fluids drawn into the module openings, and decreased flow velocities limit production rates.

Factors which should be considered in designing an embodiment of the apparatus of the present invention include the peak flow rate (which may depend on the type and nature of the artificial lift system), fluid viscosity, gas/oil ratio, and the depth at which the apparatus is installed in the wellbore (which affects actual volume of liberated gas phase). Another design factor may be the number of liquid/gas separator modules on the suction pipe of the apparatus. Optimally, the total flow into the suction pipe should be as evenly distributed among the plurality of modules as possible while, at the same time, maintaining the entry velocity of liquid entering the upwardly disposed annular opening of each module to about 0.5 feet per second (15.2 centimeters per second), depending on the other factors, and each of the plurality of modules of the apparatus acts as a self-adjusting limiter of the apparatus to maintain an evenly distributed intake among the modules because the frictional resistance to flow through the flow control pathways of each module increases as the square of the flow rate increase, thereby presenting a greater frictional flow resistance to flow through the module that takes the most flow.

In one embodiment of the apparatus, the suction pipe includes a circumferential exterior groove disposed below each aperture or set of apertures. The circumferential exterior groove can receive a retaining member such as, for example, a snap ring, a C-clip or an E-clip, to secure and support a module thereon. It will be understood that the exterior groove in the exterior of the suction pipe is spaced at a distance below the aperture or set of apertures to dispose the apertures or set of apertures at the proper position within the hole of the module that is secured in position on the suction pipe using the retaining member. In this manner, the terminus of the flow control pathways within the module is aligned with an aperture or set of apertures in the suction pipe to deliver the liquid flow stream emerging from the flow control pathways within the module into the bore of the suction pipe through the aperture or set of apertures. It will be understood that the use of a retainer member in circumferential grooves on the suction pipe is a preferred manner of supporting the modules on the suction pipe as it provides a self-aligning function for feeding a substantially gas-free liquid phase from the terminus of the flow control pathways of each module into the aperture or set of apertures aligned therewith.

In one embodiment of the apparatus, each module includes an interior circumferential channel for receiving an O-ring to seal between the module and the suction pipe to prevent produced fluid from entering the module from below. This O-ring and groove cooperate to isolate the module so that all produced fluid entering the apertures of the suction pipe enters the modules through the upwardly disposed openings.

In one embodiment of the apparatus, the modules of the apparatus are surrounded by a screen to prevent unwanted entrainment of debris that might otherwise enter the modules and plug the flow control pathways or the apertures of the suction pipe. It will be understood that particles that are sufficiently small can enter the module and pass through the module along with the liquid flow into the suction pipe.

### BRIEF DESCRIPTION OF THE SEVERAL VIEWS OF THE DRAWINGS

FIG. 1 is an elevation view of a liquid/gas separator module that can be used in an embodiment of a liquid/gas separator apparatus of the present invention.

FIG. 2 is a superior perspective view of the liquid/gas separator module of FIG. 1.

FIG. 3 is a sectioned view of the liquid/gas separator module of FIG. 1.

FIG. 4 is a plan view of the liquid/gas separator module of FIG. 1.

FIG. 5 is an elevation view of an embodiment of the liquid/gas separator apparatus of the present invention having three liquid/gas separator modules supported on a suction pipe.

FIG. 6 is a sectioned view of the liquid/gas separator apparatus of FIG. 5.

FIG. 7 is a superior perspective view of the liquid/gas separator apparatus of FIG. 6.

FIG. 8 is a panoramic view of the flow control pathways that surround the suction pipe within one of the liquid/gas separator module of the apparatus of FIG. 6.

FIG. 9 is an elevation view of an alternative liquid/gas separator module having a debris screen surrounding the upwardly disposed annular opening.

FIG. 10 is a superior perspective view of the alternative liquid/gas separator module of FIG. 9.

FIG. 11 is an elevation view of an embodiment of a liquid/gas separator apparatus including a plurality of the alternative liquid/gas separator modules of FIGS. 9 and 10 supported on a suction pipe.

FIG. 12 is a superior perspective view of the alternative liquid/gas separator apparatus of FIG. 11.

FIG. 13 is a plan view of an upper co-planar set of radially extending barriers that cooperate with the suction pipe and the interior wall of the outer shell of the module to provide the flow control pathways.

FIG. 14 is a plan view of a lower co-planar set of radially extending barriers that cooperate with the suction pipe and the interior wall of the outer shell of the module to provide the flow control pathways.

FIG. 15 is a view of a retaining member that may be received into a circumferential groove on a suction pipe to support a separation module on the suction pipe in one embodiment of the apparatus of the present invention.

### DETAILED DESCRIPTION

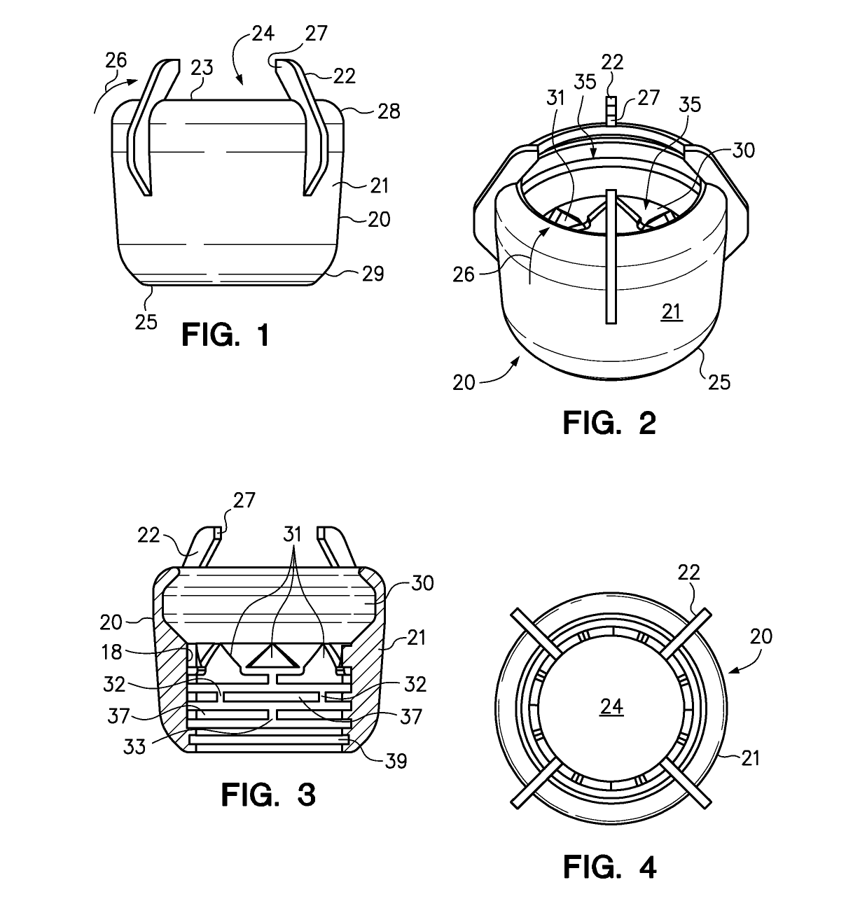

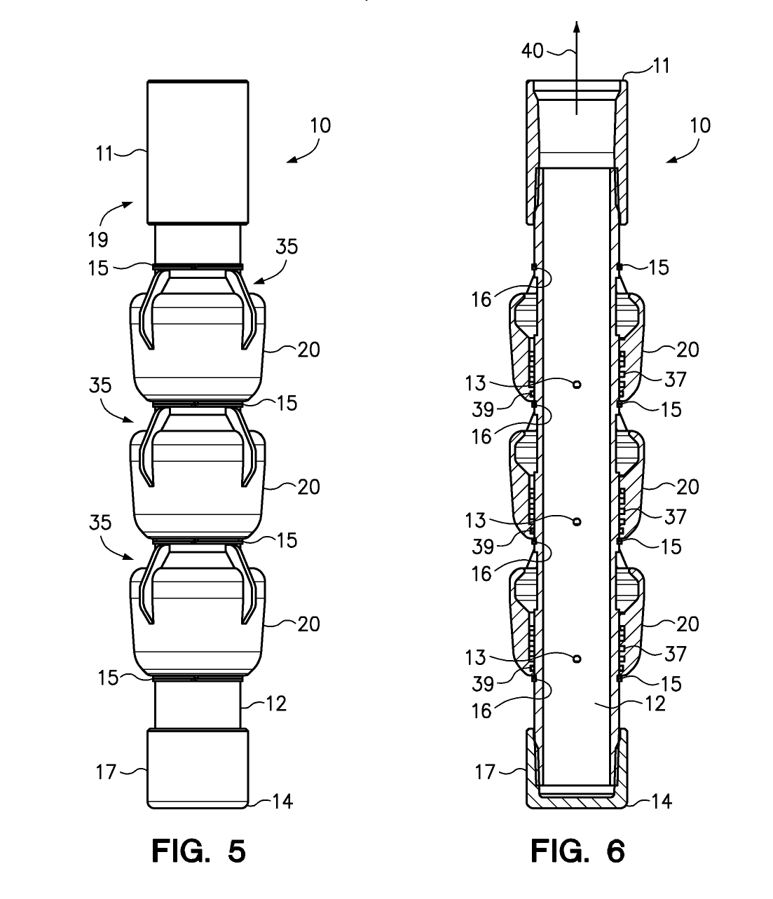

FIG. 1 is an elevation view of an embodiment of a liquid/gas separator module 20 that can be included in an embodiment of the downhole separator apparatus 10 of the present invention, which is illustrated in FIGS. 5, 6 and 7. The module 20 of FIG. 1 includes an outer shell 21 with an inwardly tapered upper portion 23 near a top 28 of the module 20 surrounding a hole 24 through the module 20. The hole 24 is for receiving a suction pipe 12 that supports and receives fluid from the module 20, as will be seen in further detail in FIGS. 5, 6 and 7. The module 20 of FIG. 1 includes a plurality of stabilizers 22 connected to the module 20, each stabilizer 22 having a radially inwardly disposed portion 27 to engage a suction pipe 12 (not shown in FIG. 1) to be received through the hole 24 of the module 20. The module 20 of FIG. 1 further includes a radially outwardly tapered portion 29 near the bottom 25 of the module 20.

FIG. 2 is a perspective view of the liquid/gas separator module 20 of FIG. 1 showing the interior chamber 30 of the module 20. FIG. 2 reveals a plurality of angularly spaced flow dividers 31 disposed within the interior chamber 30 of the module 20. The flow dividers 31 are disposed within the interior chamber 30 of the module 20 to divide and channel an incoming downwardly directed flow of fluid (not shown) received into the upwardly disposed opening 35 of the module 20 to the flow barriers (not shown in FIG. 2—see FIG. 3) within the module 20 there below.

FIG. 3 is a sectioned view of the liquid/gas separator module 20 of FIGS. 1 and 2 showing the interior chamber 30, the outer shell 21, the flow dividers 31 that divide and channel fluid flow and the radially extending flow barriers 37 extending to the interior wall 18 of the outer shell 21 and that together define the flow control pathways 32 and 33 through which fluids flow towards the terminus (not shown) of the flow control pathways that feeds into the apertures of the suction pipe 12 (not shown in FIG. 3) received through the hole 24 of the module 20. FIG. 3 also shows a seal groove 39 of the module 20 for receiving an O-ring (not shown) to seal the module 20 to the suction pipe 12 (not shown in FIG. 3) for preventing unwanted fluid flow into the module 20 from below.

FIG. 4 is a plan view of the liquid/gas separator module 20 of FIGS. 1 through 3 showing the hole 24 through the module 20 that is sized to receive a suction pipe 12. The hole 24 in the module 20 allows the suction pipe 12 to be received so that the module 20 can be positioned and supported on the suction pipe 12. It can be seen in FIG. 4 that the outer shell 21 of the module 20 is circular.

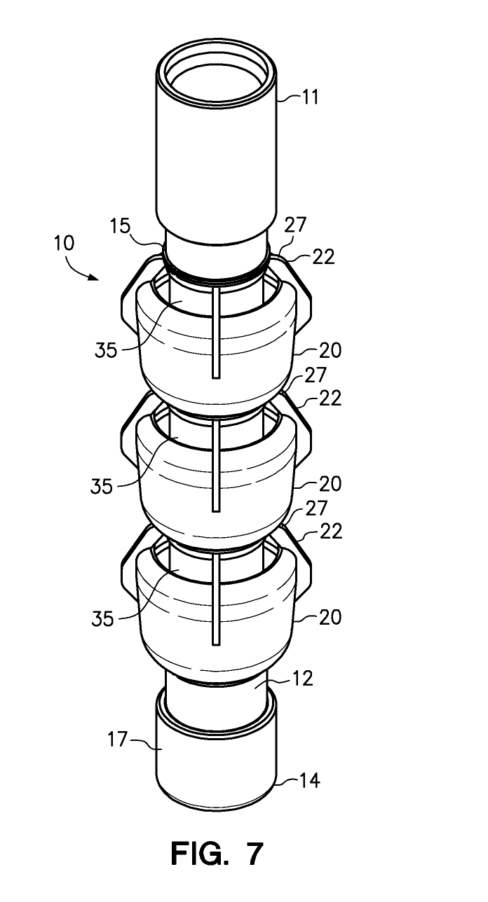

FIG. 5 is an elevation view of an embodiment of the liquid/gas separator apparatus 10 of the present invention having three liquid/gas separator modules 20 supported, in a spaced arrangement, on a suction pipe 12 received through the holes 24 of the aligned modules 20. The modules 20 of the apparatus 10 of FIG. 5 are each supported in place on the suction pipe 12 by retaining members 15 received into circumferential grooves on the suction pipe 12. As can be seen on FIG. 5, each of the modules 20 may be said to be captured on the suction pipe 12 intermediate a retaining member 15 disposed within a circumferential groove in the suction pipe 12 above and below each module 20. The separator apparatus 10 of FIG. 5 further includes a coupling 11 disposed at the upper end 19 to enable the separator apparatus 10 to be coupled to a tubular production string (not shown) through which the separated liquid from the separator apparatus 10 can be delivered to the surface end of a wellbore. It will be understood that the coupling 11 may be adapted for connecting the upper end 19 of the separator apparatus 10 to a pump suction that directs the separated liquid emerging from the separator apparatus 10 to an artificial lift device such as, for example, a sucker rod pump or a submersible electric motor-powered pump such as those available from Reda® pump available from Schlumberger Technology Corporation of Houston, Tex. The lower end 14 of the separator apparatus 10 includes a cap 17 that prevents unwanted fluid entry into the suction pipe 12 except through one of the plurality of modules 20 supported on the suction pipe 12. It will be understood that an embodiment of the apparatus 10 of the present invention may be used in combination with another piece of equipment for conditioning a produced stream of fluid for introduction into a pump. For example, but not by way of limitation, a de-sander such as, for example, a centrifugal de-sander, may be connected to the lower end 14 of the suction pipe 12. It will be further understood that the connected piece of equipment will still need to be closed, as with the lower end 14 of the embodiment of the apparatus 10 illustrated in FIGS. 5 and 6, for proper functioning and performance of the apparatus 10.

The plurality of liquid/gas separation modules 20 can be secured on the suction pipe 12 by, for example, spot welding the stabilizer 22 to the suction pipe 12 at the radially inwardly disposed portions 27 of the stabilizers 22. Alternately, as illustrated in FIG. 5, the modules 20 may be secured in position on the suction pipe 12 by application of a retaining member 15 such as, for example, an E-clip or C-clip into a circumferential groove 16 to the suction pipe 12.

FIG. 6 is a sectioned view of the liquid/gas separator apparatus 10 of FIG. 5. The sectioned view of FIG. 6 reveals a plurality of axially spaced-apart apertures 13 through which separated liquid flows from the flow control pathways 32 and 33 (not shown in FIG. 6—see FIG. 3) of the modules 20 into the suction pipe 12. It will be understood that an embodiment of the apparatus 10 may include a suction pipe 12 with axially spaced-apart sets of apertures 13 wherein each set may, for example, include two apertures that are angularly spaced one from the other by, for example, 180 degrees (it radians). FIG. 6 also shows the radially extending flow barriers 37 of the modules 20 that define the flow pathways 32 and 33 defined therebetween. FIG. 6 further illustrates the circumferential grooves 16 in the suction pipe 12 that receive retaining members 15 to secure the modules 20 in position on the suction pipe 20. FIG. 6 shows that the cap 17 on the lower end 14 of the apparatus 10 is closed to prevent fluid entry into the suction pipe 12 except through the modules 20. FIG. 6 further shows a coupling 11 through which separated liquid can flow from the suction pipe 12 and in the direction of arrow 40 into a tubular string (not shown) which can be used to transport separated liquid to the surface and to position and support the apparatus 10 in a wellbore. It will be understood that the coupling 11 can be internally threaded for threadable coupling to a tubular string (not shown).

FIG. 7 is a superior perspective view of the liquid/gas separator apparatus 10 of FIG. 6 illustrating the upwardly disposed opening 35 of each module 20 that is formed between the suction pipe 12 and the interior chamber 30 of the module 20. It can be seen that, due to the closed cap 17 on the lower end 14 of the apparatus 10, produced fluids can enter the suction pipe 12 only by first entering a module 20 of the apparatus 10 through an opening 35 of the module 20. This requires that the fluids must initially flow downwardly and into the interior chamber 30 of the module 20, which is accessible only through the opening 35. The fluids are diverted and channeled by the flow dividers 31 (not shown in FIG. 7—see FIGS. 2 and 3) to the flow control pathways 32 and 33 defined between the radially extending flow barriers 37 (see FIG. 3). FIG. 7 further illustrates how the stabilizers 22 of the modules 20 can be used to secure the modules 20 both radially relative to the suction pipe 12 and vertically relative to adjacent modules 20.

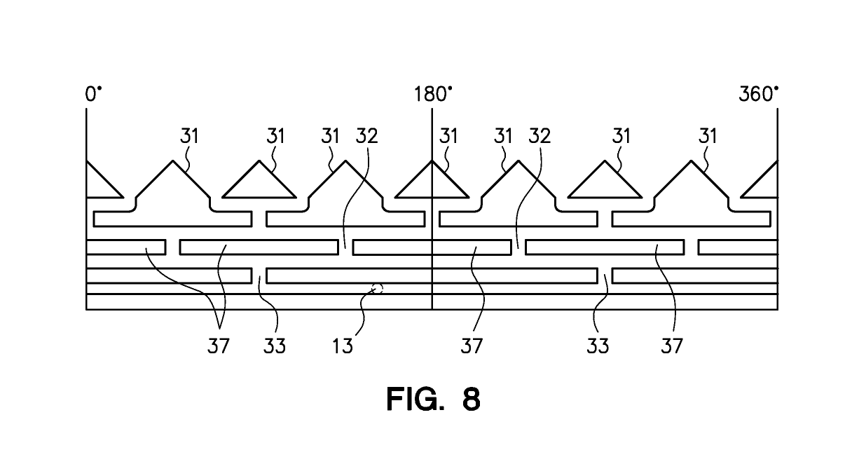

FIG. 8 is a 360 degree (2π radians) panoramic view of the flow control pathways 32 and 33 of a module 20 that surround the suction pipe 12 of the apparatus 10 of FIG. 7. It will be understood that the panoramic view of FIG. 8 is what would be seen by someone standing in the center of the hole 24 in the module 20 (absent the suction pipe 12) and rotating once to view the entire surrounding interior chamber 30 of the module 20. FIG. 8 shows the flow diverters 31 that redirect and channel the fluids flowing downwardly through the opening 35 (not shown) and into the interior chamber 30 of the module 20 (not shown) to the radially outwardly extending flow barriers 37 that together define a plurality of flow pathways 32 and 33. It will be understood that the radially extending flow barriers 37 are both vertically and radially separated one from the others by gaps. The vertical gaps between horizontally adjacent flow barriers 37 are flow pathways 32, and the horizontal gaps between adjacent or “stacked” flow barriers 37 are flow pathways 33. The flow pathways 32 and flow pathways 33 together make up flow control pathways that create a tortuous path around and between flow barriers 37. The module 20 can be positioned on the suction pipe 12 to position the aperture 13 of the suction pipe 12 (see FIG. 6) to receive a stream of fluid exiting the flow pathways 32 and 33 of the module 20 (a set consisting of a single aperture 13 of the suction pipe 12 shown in position relative to the pathways 32 and 33 as dashed circle).

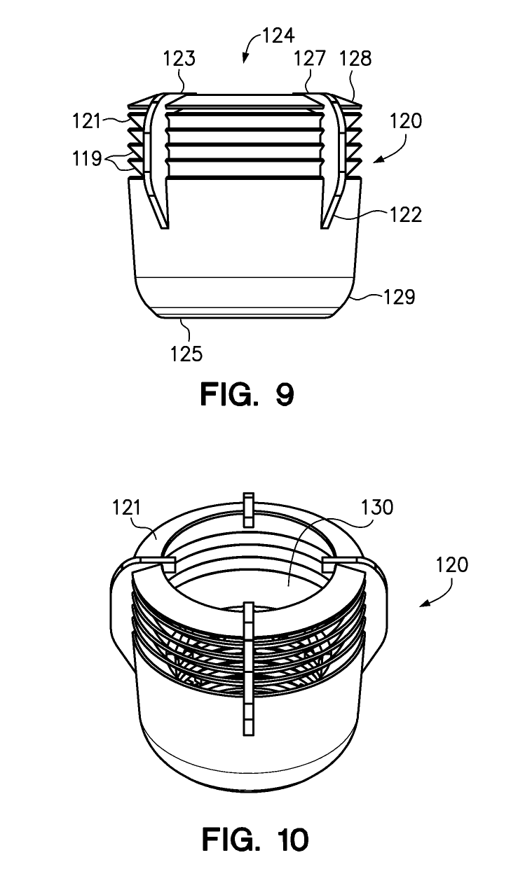

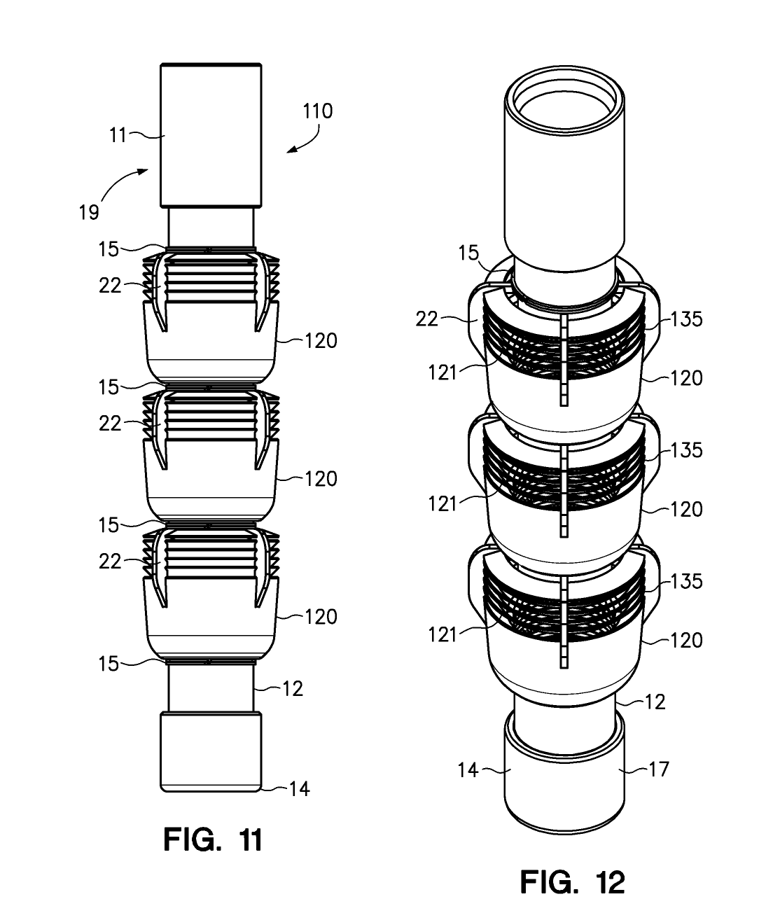

FIG. 9 is an elevation view of an alternative liquid/gas separator module 120 having a debris screen 121 surrounding the upwardly disposed hole 124. The debris screen 121 includes a plurality of aligned and tapered rings 119 that are spaced-apart to prevent debris exceeding the separation distance of the rings 119 from entering the module 120. Debris of a size smaller than the separation distance of the rings 119 may enter the module 120, and the flow control pathways 32 and 33, and the apertures 13 of the suction pipe 12, should be sized to pass these smaller pieces of debris into the suction pipe 12. The module 120 of FIG. 9 includes an outer shell 121 with an inwardly tapered upper portion 123 near a top 128 of the module 120 surrounding the hole 124 through the module 120. The hole 124 is for receiving a suction pipe 12, as will be seen in further detail in FIGS. 11 and 12. The module 120 of FIG. 9 includes a plurality of stabilizers 122 connected to the module 120, each stabilizer 122 having a radially inwardly disposed portion 127 to engage a suction pipe 12 (not shown in FIG. 9—see FIGS. 11 and 12) to be received through the hole 124 of the module 120. The module 120 of FIG. 9 further includes a radially outwardly tapered portion 129 near the bottom 125 of the module 120.

FIG. 10 is a perspective view of the liquid/gas separator module 120 of FIG. 9 showing the interior chamber 130 of the module 120. The plurality of angularly spaced flow dividers disposed within the interior chamber 130 of the module 120 are not visible due to the debris screen 121, but are generally the same as those illustrated in FIG. 2.

FIG. 11 is an elevation view of an embodiment of a liquid/gas separator apparatus 110 including a plurality of the alternative liquid/gas separator modules 120 of FIGS. 9 and 10 supported on a suction pipe 12. The liquid/gas separator apparatus 110 of FIG. 11 includes three of the alternative liquid/gas separator modules 120 of FIGS. 9 and 10 supported, in a spaced arrangement, on a suction pipe 12 received through the holes 124 of the aligned modules 120. The separator apparatus 110 of FIG. 11 includes a coupling 11 disposed at the upper end 19 to enable the separator apparatus 110 to be coupled to a tubular production string (not shown) through which the separated liquid from the separator apparatus 110 can be delivered to the surface end of a wellbore. As with the embodiment of the apparatus 10 illustrated in FIGS. 5 and 6, the coupling 11 of the apparatus 110 of FIG. 11 may be adapted for connecting the upper end 19 of the separator apparatus 110 to a pump suction that directs the separated liquid emerging from the separator apparatus 110 to an artificial lift device such as, for example, a sucker rod pump or a submersible electric motor-powered pump such as those available from Reda® pump available from Schlumberger Technology Corporation of Houston, Tex. The lower end 14 of the separator apparatus 110 includes a cap 17 that prevents unwanted fluid entry into the suction pipe 12 except through one of the plurality of modules 120 supported on the suction pipe 12.

FIG. 12 a superior perspective view of the liquid/gas separator apparatus 110 of FIG. 12 illustrating the screened openings 135 of each module 120 that are formed between the suction pipe 12 and the interior chamber 30 (not shown in FIG. 12—see FIG. 10) of each module 120 and which is surrounded by debris screens 121. It can be seen that, due to the closed cap 17 on the lower end 14 of the apparatus 10, produced fluids can enter the suction pipe 12 only by first entering a module 120 of the apparatus 110 through an opening 135 of the module 120. This requires that the fluids must initially flow downwardly and into the interior chamber 130 of the module 120, which is accessible only through the opening 135.

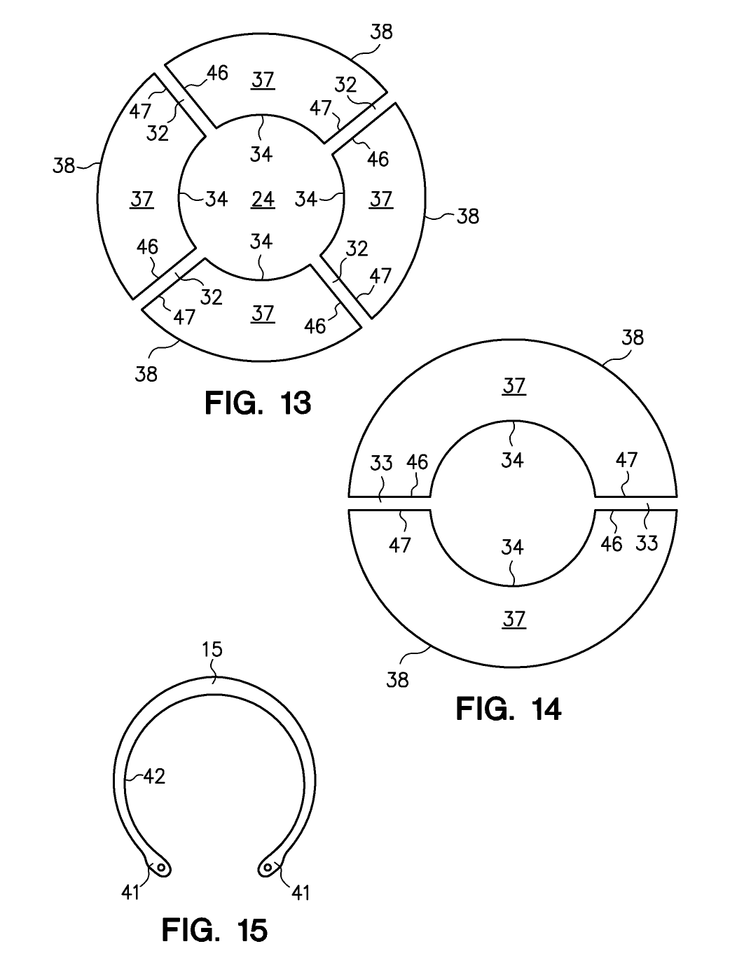

FIG. 13 is a plan view of an upper co-planar set of radially extending flow barriers 37 that cooperate with the suction pipe 12 (not shown in FIG. 13—see FIG. 3) and the interior wall 18 of the outer shell 21 (not shown in FIG. 13—see FIG. 3) of the module 20 to provide the flow control pathways. The radially extending flow barriers 37 define flow control pathways 32 therebetween, and cooperate with adjacent flow barriers that may be either above or below the radially extending flow barriers 37, or both, to further define flow control pathways between these radially extending flow barriers 37 and the adjacent flow barriers. The radially extending flow barriers 37 of FIG. 13 sealably engage the suction pipe 12 (see FIG. 6) along a radially inwardly disposed edge 34 and sealably engage the interior wall 18 of the outer shell 21 of the module 20 (see FIG. 3) along the radially outwardly disposed edge 38, thereby isolating flow to penetrate the plane of the radially extending flow barriers 37 through flow control pathways 32. Each radially extending flow barrier 37 in FIG. 13 includes a first edge 46 that is angularly spaced from a second edge 47. The flow control pathways 32 intermediate adjacent each of the radially extending flow barriers 37 are each defined by a first edge 46 of a first radially extending flow barrier 37 and a second edge 47 of an adjacent radially extending flow barrier 37.

FIG. 14 is a plan view of a lower co-planar set of radially extending flow barriers 37 that cooperate with the suction pipe 12 (not shown in FIG. 14—see FIG. 3) and the interior wall 18 of the outer shell 21 (not shown in FIG. 14—see FIG. 3) of the module to provide the flow control pathways. The radially extending flow barriers 37 define flow control pathways 33 therebetween, and cooperate with adjacent flow barriers that may be either above or below the radially extending flow barriers 37, or both, to further define flow control pathways between these radially extending flow barriers 37 and the adjacent flow barriers. The radially extending flow barriers 37 of FIG. 14 sealably engage the suction pipe 12 (not shown in FIG. 14) along a radially inwardly disposed edge 34 and sealably engage the interior wall 18 of the outer shell 21 of the module 20 along the radially outwardly disposed edge 38, thereby isolating flow to penetrate the plane of the radially extending flow barriers 37 through flow control pathways 33. Each radially extending flow barrier 37 in FIG. 14 includes a first edge 46 that is angularly spaced from a second edge 47. The flow control pathways 33 intermediate adjacent each of the radially extending flow barriers 37 are each defined by a first edge 46 of a first radially extending flow barrier 37 and a second edge 47 of an adjacent radially extending flow barrier 37. The radially extending flow barriers 37 of FIG. 14 are, in one embodiment of the separation module 20 of the apparatus 10, disposed below the radially extending flow barriers 37 of FIG. 13 to isolate the flow control pathways to a progressively smaller cross-sectional flow area starting from the low flow velocity at the upwardly disposed opening of the module 35 (see FIG. 2) to the high flow velocity at the terminus adjacent to the aperture 13 of the suction pipe 12. The two levels within the module 20 occupied by the radially extending flow barriers 37 of FIG. 13 and by those of FIG. 14 can be compared to the panoramic view of FIG. 8.

FIG. 15 is a view of a retaining member 15 that may be received into a circumferential groove 16 on a suction pipe 12 to support a separation module 20 on the suction pipe 12 in one embodiment of the apparatus 10 of the present invention. The remaining member 15 of FIG. 15 is a generally “C”-shaped and resilient member having two enlarged ends 41 that are received into a circumferential groove 16 on the suction pipe 12 (not shown in FIG. 15—see FIG. 6). The retaining member 15 is then forced forward, towards the two enlarged ends 41 to spread the enlarged ends 41 apart and to resiliently snap back into place when the interior edge 42 intermediate the two enlarged ends 41 seats into the circumferential groove 16 on the suction pipe 12.

An embodiment of the separator apparatus 10 of the present invention may be placed in a borehole above perforations through which produced fluids may enter the borehole. As fluids are separated and withdrawn from the borehole through the apparatus 10, produced fluids will move upwardly within the borehole from the perforations. Returning to FIG. 1, it will be understood that, at the onset of the separation process, a gas and liquid solution can flow upwardly and around the upwardly tapered portion 29 at the bottom 25 of the module 20. The withdrawal of fluids from the coupling 11 of the apparatus 10 (not shown in FIG. 1—see FIG. 6) will cause fluids to be drawn radially inwardly and across the inwardly tapered upper portion 23 near the top 28 of the module 20, as indicated by arrow 26, and then downwardly into the opening 35 (see FIG. 2) formed between the suction pipe 12 and the module 20 and into the interior chamber 30 (FIG. 2).

Embodiments of the apparatus 10 of the present invention are structured to utilize the buoyancy of gas bubbles to promote separation of liquid phase and gas phase. The buoyancy of gas bubbles moving with a liquid phase around the outside surface of the module 20 will tend to keep the gas bubbles moving upwardly and away from the top 28 of the module 20 as the liquid phase of the produced fluids flow radially inwardly (as indicated by arrow 26 in FIGS. 1 and 2) and then downwardly through the opening 35 and into the interior chamber 30 of the module 20. Turning to FIG. 8 again, the fluid that enters the module 20 is channeled by the flow diverters 31 to the flow control pathways 32 and 33 defined by the radially extending flow barriers 37. The separated liquid flows through the flow control pathways 32 and 33 to the set of apertures 13 (indicated by dotted line) of the suction pipe 12 (see FIG. 6).

One method of manufacturing the separator modules 20 of the apparatus 10 of the present invention is by casting. It will be understood by those skilled in the art of machining and casting that making the separator modules 20 of the present invention by means other than casting will result in a substantially increased cost of manufacture.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. An apparatus, comprising:
a suction pipe having a bore, an outer diameter, an upper end connectable to an artificial lift pump, a closed lower end and a plurality of apertures through a pipe wall between the upper end and the lower end of the suction pipe; and
a plurality of separator modules, each having an outer shell, a central hole to receive the suction pipe, thereby forming an upwardly disposed annular opening into each separator module that is larger in diameter than the outside diameter of the suction pipe and smaller in diameter than the outer shell, the upwardly disposed annular opening of each separator module to receive a circumferential and downwardly directed flow of fluid into the separator module, each of the separator modules further comprising a plurality of radially extending flow barriers arranged within the outer shell of the separator module to define a plurality of flow control pathways to carry fluid flow entering the upwardly disposed annular opening from an interior of the separator module to a terminus of the plurality of flow control pathways that is in fluid communication with at least one of the plurality of apertures through the pipe wall of the suction pipe;
wherein the apparatus is adapted for being used in a generally vertical orientation within a well to promote buoyancy separation of gas bubbles of a produced fluid stream from a substantially liquid phase of the produced fluid stream flowing radially circumferentially inwardly above each of the plurality of separator modules and then downwardly and into the upwardly disposed annular opening of each of the plurality of separator modules.

2. The apparatus of claim 1, wherein the plurality of apertures in the wall of the suction pipe comprises a plurality of axially spaced-apart apertures; and
wherein at least one of the plurality of separator modules is positioned about each of the plurality of axially spaced-apart apertures in the wall of the suction pipe; and
wherein a terminus of the flow control pathways within each of the separator modules is aligned with at least one of the plurality of apertures in the suction pipe.

3. The apparatus of claim 1, wherein the outer shell of the at least one separator module further comprises an inwardly tapered upper portion.

4. The apparatus of claim 1, wherein each of the plurality of radially extending flow barriers include plates having a radially inwardly disposed edge abutting an exterior wall of the suction pipe.

5. The apparatus of claim 4, wherein each of the plurality of the radially extending flow barriers include a first edge angularly spaced from a second edge.

6. The apparatus of claim 5, wherein the first edge of each of the plurality of radially extending flow barriers is straight and aligned with a center of the suction pipe.

7. The apparatus of claim 6, wherein the second edge is straight and aligned with a center of the suction pipe; and
wherein the first edge is angularly spaced from the second edge.

8. The apparatus of claim 7, wherein the plurality of radially extending flow barriers of each of the separator modules includes a plurality of plates, each having a radially outwardly disposed edge abutting an interior wall of an outer shell of the separator module.

9. The apparatus of claim 2, wherein the plurality of apertures consist of a plurality of axially spaced-apart single apertures.

10. The apparatus of claim 2, wherein the plurality of apertures consist of sets of apertures wherein each set of apertures includes two apertures, each aperture axially aligned but angularly spaced one from the other.

11. The apparatus of claim 1, wherein the suction pipe further includes at least one exterior groove to receive a clip to support the at least one module on the suction pipe.

12. An apparatus, comprising:
a suction pipe having a bore, an outer diameter, an open upper end for connecting to an artificial lift pump, a closed lower end and a plurality of sets of one or more apertures through a pipe wall between the upper end and the lower end; and
a plurality of separator modules, each having an outer shell, a central hole to receive the suction pipe to thereby form an upwardly disposed annular opening in each of the plurality of separator modules, the upwardly disposed annular opening being larger in diameter than the suction pipe, to receive a circumferential and downwardly directed flow of fluid into each of the plurality of separator modules, each separator module further having a plurality of radially extending flow barriers therein arranged to define a plurality of flow control pathways to receive the fully circumferential and downwardly directed flow of fluid into the separator module and to direct the flow of fluid to a terminus of the flow control pathways that is aligned with and in fluid communication with one of the plurality of sets of one or more apertures through the pipe wall of the suction pipe;
wherein the apparatus, in a generally vertical orientation within an earthen well, promotes buoyancy separation of gas bubbles in a produced fluid stream from a liquid phase of the produced fluid stream.

13. The apparatus of claim 12, wherein the plurality of sets of one or more apertures in the wall of the suction pipe comprises a plurality of axially spaced-apart sets of one or more apertures; and
wherein the plurality of separator modules comprises a plurality of separator modules corresponding in number to the plurality of axially spaced-apart sets of one or more apertures.

14. The apparatus of claim 12, wherein the outer shell of each of the plurality of separator modules further comprises an inwardly tapered upper portion.

15. The apparatus of claim 12, wherein the radially extending flow barriers within each of the plurality of separator modules includes plates having a radially inwardly disposed edge abutting an exterior surface of the suction pipe.

16. The apparatus of claim 15, wherein each of the radially extending flow barriers includes a first edge angularly spaced from a second edge.

17. The apparatus of claim 16, wherein the first edge is straight and aligned with a center of the suction pipe.

18. The apparatus of claim 6, wherein the second edge is straight and aligned with the center of the suction pipe; and
wherein the first edge is angularly spaced from the second edge.

19. The apparatus of claim 18, wherein each of the radially extending flow barriers comprises a plate having a radially outwardly disposed edge abutting an interior wall of an outer shell of the module that surrounds the radially extending flow barriers.

20. The apparatus of claim 13, wherein the plurality of sets of one or more apertures consist of a plurality of single apertures.

21. The apparatus of claim 13, wherein the plurality of sets of one or more apertures consist of a plurality of sets of a plurality of apertures, each set axially spaced along the suction pipe from at least one adjacent set.

22. The apparatus of claim 13, wherein the suction pipe further includes at least one exterior groove to receive a clip to support at least one of the plurality of separator modules on the suction pipe.
